(19) United States
(12) Patent Application Publication
(10) Pub. No.: US 2007/0130078 A1
(43) Pub. Date: Jun. 7, 2007

(54) Digital rights management compliance with portable digital media device

(76) Inventor: Robert Grzesek, Redondo Beach, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/293,410

(22) Filed: Dec. 2, 2005

(51) Int. Cl. G06Q 99/00

(52) U.S. Cl. 705/59

(57) ABSTRACT

A system for digital rights management in a portable digital media device is presented in which the portable digital device obtains a license for a digital media file with the assistance of a proxy application. A license request is formulated in and sent from the portable digital media device to a proxy application residing on a host device. The proxy application forwards the license request to a license server. The license server fulfills the license request and sends the license to the proxy application, which then forwards the license to the portable digital media device. The described digital rights management system implements a method for indirect or modified direct license acquisition.

### BACKGROUND

Digital rights management refers to any one of many technologies used to control, restrict, or prohibit the use of digital media content on an electronic device with one of the technologies installed. Commonly, digital rights management is used to control, restrict, or prohibit access to digital data files encoding works of music, works of art, or movies.

Digital rights management applies only to digital media. Digital media files are becoming more and more popular because of their perceived higher quality, and because of their ease of manufacture, duplication, and manipulation. Digital media files are capable of being copied an almost limitless number of times with modern computer equipment, with no concomitant loss of quality from the original to the one or more copies. In contrast, analog media files may not be copied an almost limitless number of times, due to degradation of the media itself and because of a loss of signal quality from the original to the one or more copies. Analog media files may also suffer signal loss through an aging process, at a rate greater than that for digital media files.

The Microsoft Windows Media DRM 10 application utilizes a new digital rights management (“DRM”) system called Janus. In the Janus system, the portable media player device requires both an encrypted media file and a matching license file containing the information required to decrypt the information in the media file. The license file is unique to a given media player device and cannot be used on a second device. The media file includes information about which server on the Internet is authorized to provide a license to the media player device.

Janus includes two methods for license acquisition: direct license acquisition (DLA) and indirect license acquisition (ILA). DLA is used in a media player device when the device is configured to directly access the Internet. Devices configured for DLA include personal computers, set top boxes, mobile phones, personal digital assistants, and so on. In the case of each of the noted devices, the device makes a direct connection to a DRM server on the Internet to download a license for a media file. ILA is used in a media player device when the device is connected to the Internet via an intermediate device, such as a personal computer (“PC”). In the case of a device utilizing ILA, a PC may download a media file to the media player device using a media transport protocol(“MTP”), which is a new standard media transport protocol used with Windows Media 10. The PC may then provide a license to the media player device using the MTP if the PC has the right to transfer a license to a portable media player device.

Unfortunately for the above-described system, MTP and Windows Media 10 applications are only available to run on the Windows XP computer operating system. Therefore, only Windows XP-compatible personal computers may be used for ILA. Until now, if a portable digital media player device was not configured to utilize DLA, and there was not a Windows XP-compatible personal computer available for ILA, that portable digital media player device could not acquire and/or utilize an appropriate license file for unlocking a given media file protected by the Janus DRM system.

Examples of methods and systems for digital rights management may be found in U.S. Patents and Patent Application Publications numbered U.S. Pat. Nos. 6,615,349, 6,772,340, 6,775,655, 6,816,596, US20020013772, US20020108049, US420020138593 US20030018582, US20030078853, US20030084306, US20030161473, US20030167392, US20030191623, US20030194092, US20030220781, US20040024580, US20040054920, US20040098348, US20040143736, US20040148262, US20040175098, US20040181490, US20040196972, US20040236444, US20050004873, US20050013589, US20050021783, US20050038707, US20050038724, US20050086478, US20050091275, US20050091283, US20050091507, US20050102237, US20050131832, US20050135682, US20050175030, US20050192907, US20050204405, and US20050216743. The contents of the above-noted patents and patent application publications are hereby incorporated by reference in their entireties for all purposes.

### SUMMARY

The present disclosure provides a system and method for acquiring indirect access to a data file subject to digital rights management, such as in a situation where a portable media player device used for manipulating the file is not configured to connect to a digital rights management license server.

### BRIEF DESCRIPTION OF THE DRAWINGS

FIG. 1 is a schematic depiction of one embodiment of a system for digital rights management according to the present disclosure.

FIG. 2 is a flowchart of steps involved in acquiring a license file according to the present disclosure.

### DETAILED DESCRIPTION

In a case where a portable digital media player device is not configured to utilize DLA, and there is not a Windows XP-compatible personal computer available for ILA, it may be possible to use an intermediate device as a proxy to connect to the Internet for acquisition of an appropriate license file via DLA. In such a scenario, the proxy device may generate all the HTTP/HTTPS requests that are sent to the proxy device from the portable digital media player device. The requests may be sent from the portable device to the proxy device via a proprietary universal serial bus (“USB”) protocol, or a FireWire protocol, or any other appropriate communication protocol. The proxy device may be configured to run a proxy application that forwards a license request from the portable digital media player to the appropriate license server for processing. In this manner, the proxy device acts essentially as a relay between the digital media device and the license server from which the licensing file is to be obtained. In other words, the proxy device allows a device that cannot, by itself, communicate with the license server via the Internet, to acquire a licensing file. This “proxy relay” may allow users of computers running operating systems other than a Windows XP operating system to benefit from the use of files protected by the Janus DRM without upgrading to the Windows XP operating system.

Of note, a proxy application running on a proxy device may be written to execute on a particular computer operating system, or it may be written as an application or “applet” that is configured to execute on a variety of different computer operating systems, or it may execute in an operating system-independent manner. Also, the proxy application may be configured to allow a portable digital media device to acquire digital media files, and/or any other file type than a licensing file, via the Internet or other local or wide area network.

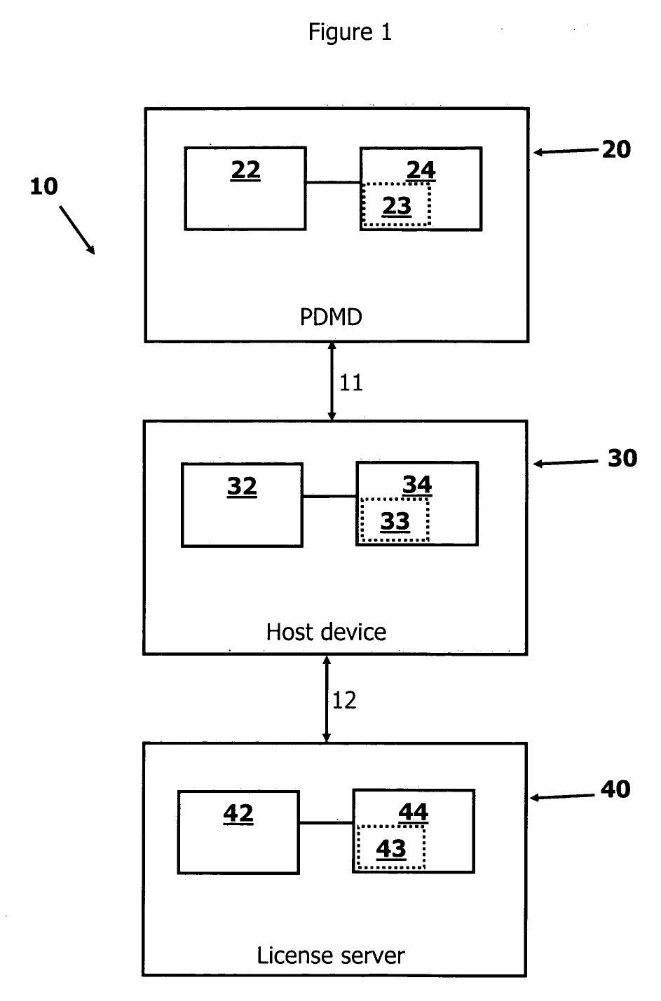

FIG. 1 illustrates some components that may be present in a digital rights management system 10 as described in the present disclosure. The disclosed system may contain a portable digital media device (portable digital media device) 20, a host device 30, and a license server 40. Communication may occur between the portable digital media device and the host device, as shown by arrow 11, and between the host device and the license server as shown by arrow 12. The communication may be within a computing device, via a local area network, via a wide area network, or any combination of these networks or their characteristics.

A portable digital media device 10 may include a processor 22 and a memory 24. Within a memory 24 of the portable digital media device there may be contained various files, and software instructions facilitating the function of the portable digital media device. Included among the files on the portable digital media device may be a digital data file 23, which may be any kind of media file, including an audio file, or a video file, a combination audio/video file, or other type of file. The processor 22 and the memory 24 may be operatively connected within the portable digital media device such that the processor may access files stored in the memory and utilize them appropriately. For example, processor 22 could access an audio digital data file 23, process that audio file, and output the resulting information to, for example, an audio output (not shown), such as speakers, or a jack to which a pair of headphones are connected. Alternatively, the audio data could be sent to an audio output suitable for connecting to a stereo through a set of RCA connections, or through a USB connection, or any other suitable data transfer connection.

A portable digital media device may communicate, via any appropriate communication medium 11, with a host device 30, also referred to as an intermediate device or a proxy device. The host device 30, like the portable digital media device, may include a processor 32 and a memory 34. Included within the memory of the host device may be a number of files and software instructions for facilitating the function of the host device. Included among the files on the host device 30 may be a set of software instructions of a proxy application 33. The host device may take the form of a microprocessor, a personal computer, or PC, though any computing device configured to implement the described digital rights management system would be sufficient. The host device, if a personal computer, may run an operating system, such as a Microsoft Windows™ or an Apple™ operating system. However, as noted above, the proxy application which facilitates communication with the portable digital media device may be a platform-independent application, or applet.

A host device in the disclosed system may communicate with a license server 40. The license server, like the portable digital media device and the host device, may include a processor 42 and a memory 44. The memory 44 may include a number of files and software instructions 43 for facilitating the function of the license server. Included among the files on the license server may be a set of software instructions useful to configure the license server for receiving one or more license requests from a host device 30, for formulating file licenses, and for sending one or more licenses to the host device. As with the host device, a license server may take the form of a personal computer, a server stack, or any other appropriate computing device. The license server may be located remotely from or near to the host device and/or the portable digital media device, though the license server may be communicatively coupled to at least the host device no matter their relative spatial locations. Such communicative coupling between the license server and the host device may occur over a modem connection, over the Internet, over a LAN, or a WAN, over a wireless network, over any other appropriate communications medium, or over a combination of these.

A digital media file may be packaged with information besides the data comprising the song or video the user wishes to hear. A packaged file may also include an Internet address for a license server containing the license for the file, or descriptive information regarding the file, a unique media identifier, or any other appropriate information. The packaged and locked file may exist on the user's portable digital media device or it may be downloaded to, saved to, played on, or otherwise placed on the portable digital media device for later use.

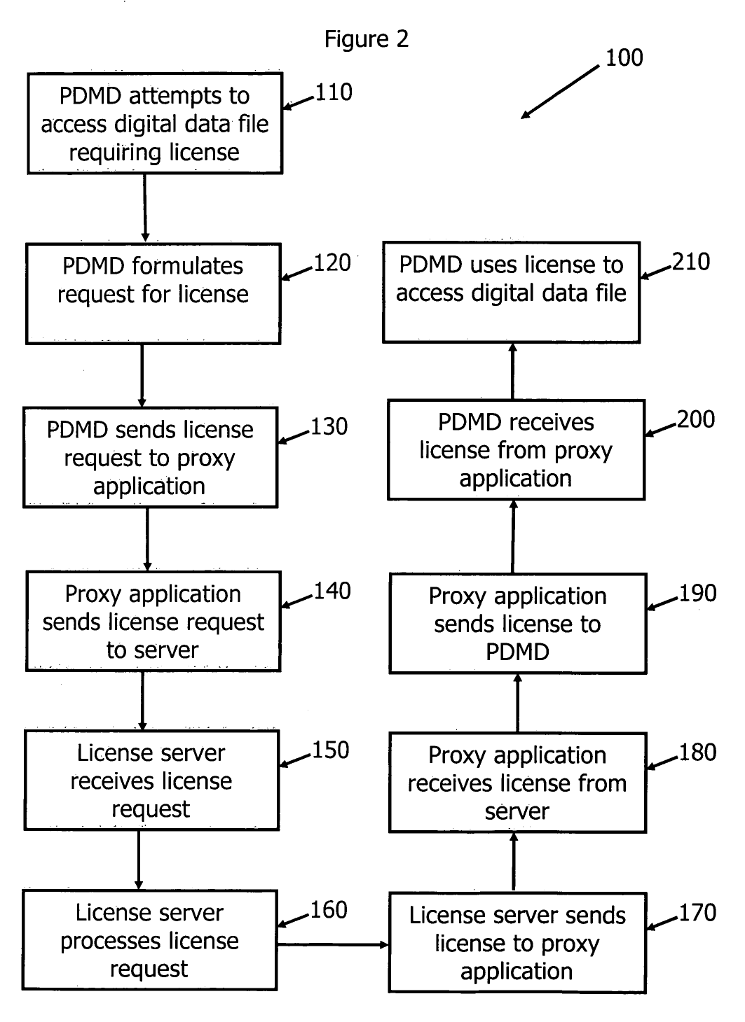

When a user of the portable digital media device wishes to play an encrypted digital media file on the portable digital media device, the user must acquire a license that contains a key to unlock the file before it can be played. For example, a user may wish to play a music file or a video file that has been protected by the Janus DRM system of Windows Media DRM. In such a DRM system, a digital media file may be encrypted and locked with a “key.” The locked file may only be played by a person who, or on a device which, has obtained a license to unlock the file. The process of acquiring a license for a digital media file may occur at the user's request, or it may occur automatically. For example, the license request may occur automatically when a user attempts to play or otherwise access a locked file. Such a license request by a portable digital media device may occur according to a scheme like that shown at 100 in FIG. 2.

For license acquisition to occur, the portable digital media device may first be required to attempt to access a digital media date file, as in step 110. Upon attempting to access a file that requires a license, the portable digital media device may formulate 120 and send 130 a license request to a proxy application implemented on a host device. To send a license request to the host device, the portable digital media device may need to initiate communication with the host device, if the two devices are not already in communication. Such communication may occur via a wireless connection, or a wired connection; the devices may be part of a local area network, or a wide area network, or any other connection scheme. For example, the portable digital media device and the host device may communicate wirelessly, over a USB connection, over a FireWire™ connection, or over any other appropriate connection. The portable digital media device may initially send the license request to the proxy application on the host device because the portable digital media device may be incapable of direct license acquisition from the license server. Alternatively, the portable digital media device may be capable of either direct license acquisition, or “indirect” license acquisition (from the portable digital media device to the proxy device to the license server).

As noted above, an initial license request may be made from a portable digital media device to a proxy application running on a host device. The host device, in turn, may, via the proxy application, formulate a license request that can be transmitted to a license server. The license request may identify the portable digital media device used to access a selected digital media file, and/or the identity of the selected digital media file, and/or the host device, and/or any other information needed to acquire a license for the digital media file. The license request, once formulated, may be sent to the license server for fulfillment 140.

The proxy application in this system may essentially mimic the digital rights management request built into the Windows XP™ operating system, or it may function in a direct license acquisition mode. As such, the proxy application may run on an operating system that is not Windows XP™, and it may run either as an operating-system-dependent application or as an operating-system-independent application, such as a Java™ applet. In performing its functions, the proxy application may need to communicate with a specific portable digital media device attached to the host device on which the proxy application is running, and the proxy application may need to perform all the digital rights management tasks that the host device would perform if it were running Windows XP™.

The license server may receive the license request 150 from the proxy application and formulate or access the appropriate license 160 for a given digital media file, portable digital media device, or host device. The license server may then send the chosen license 170 to the host device for receipt and processing by the proxy application 180. The host device, via the proxy application, may then send the license to the portable digital media device 190 for further use. When appropriate, a license providing access to the host device may be converted to a license for use by the portable digital media device. The portable digital media device, in turn, may receive 200 and use 210 the acquired license to access the digital data file.

The above-described method, because it uses a proxy application as the “go-between” between a portable digital media device and a license server, may be referred to as indirect license acquisition, or ILA. ILA may be contrasted with a situation where the portable digital media device itself requests and receives a license from the license server; such a method might properly be called direct license acquisition, or DLA. Optionally, the host device may interface with the license server using the DLA method. ILA may occur, as described, upon a user's intervention, or it may occur in the absence of a discrete user input. For example, the user may enter a piece of data into the portable digital media device commanding it to request a license. As another possibility, the user may purchase a license beforehand and have it transferred from a license server, to a host device running a proxy application, and thence to the user's (or someone else's) portable digital media device. Alternatively, the portable digital media device may request a license automatically when, or if, it detects a digital media file that has not been previously accessed and which requires a license. As well, the proxy application may function in the above system in the absence of any input or control by the user of the portable digital media device.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A method for obtaining access to information contained within a digital data file subject to a system of digital rights management, the method comprising:
receiving a license request from a portable digital media device;
forwarding a license request to a digital data file license server based on the received license request;
receiving license data from the digital data file license server; and
forwarding received license data to the portable digital media device.

2. The method of claim 1, wherein each of the steps is performed by a proxy application embodied in a computer-readable medium containing software instructions and further wherein the proxy application is operable in a computer operating system other than a Windows XP™ operating system.

3. The method of claim 2, wherein the proxy application is an operating-system-dependent application.

4. The method of claim 2, wherein the proxy application is an operating-system-independent application.

5. The method of claim 1, wherein the steps of forwarding the license request to a digital data file license server and receiving license data from the digital data file license server occur over a network.

6. The method of claim 5, wherein the network is one or more of a wide area network, a local area network, and a wireless communication network.

7. The method of claim 1, further comprising sending with the forwarded license request a device identification of a device other than the portable digital media device.

8. The method of claim 7, wherein forwarding the license data includes forwarding the license data without the sent device identification.

9. The method of claim 1, where the steps of receiving and forwarding are performed by a host device and wherein forwarding a license request includes forwarding a license request appropriate for licensing the host device.

10. The method of claim 9, wherein receiving license data includes receiving license data authorizing the intermediate device to access the information contained within the digital data file, the method further comprising converting the license data to license data authorizing the portable digital media device to access the information contained within the digital data file.

11. The method of claim 1, where the steps of receiving and forwarding are performed by a host device, and wherein forwarding a license request includes forwarding a license request appropriate for licensing the portable digital media device.

12. A method for obtaining access to information contained within a digital data file subject to a system of digital rights management, the method comprising:
formulating a license request in a portable digital media device;
sending the license request to a host device executing a proxy application;
receiving in the digital media device license data from the host device; and
using in the digital media device the license data to access information contained within the digital data file.

13. The method of claim 12, wherein the proxy application is embodied in a computer-readable medium containing software instructions, and the proxy application is operable in a computer operating system other than Windows XP™.

14. The method of claim 13, wherein the proxy application is an operating-system-dependent application.

15. The method of claim 13, wherein the proxy application is an operating-system-independent application.

16. The method of claim 12, wherein the steps of sending the license request to a host device and receiving license data from the host device occur over a network.

17. The method of claim 16, wherein the network is one or more of a wide area network, a local area network, and a wireless communication network.

18. A digital rights management system for providing access to information contained within an encrypted digital data file, comprising:
a portable digital media device;
a license server; and
a host device configured to execute a proxy application, wherein the proxy application is embodied in a computer-readable medium containing software instructions, and further wherein the host device, when executing the proxy application, is configured to receive a license request from a portable digital media device; forward the license request to a digital data file license server; receive license data from the digital data file license server; and send the license data to the portable digital media device.

19. The system of claim 18, wherein the proxy application is an operating-system-dependent application.

20. The system of claim 18, wherein the proxy application is an operating-system-independent application.

21. The system of claim 18, wherein the portable digital media device, the license server, and the host device including the proxy application comprise a network.

22. The system of claim 21, wherein the network is one or more of a wide area network, a local area network, and a wireless communication network.

23. The system of 18, wherein the host device is further configured to send with the forwarded license request a device identification of a device other than the portable digital media device.

24. The system of 23, wherein the forwarded license data lacks the sent device identification.

25. The system of 18, wherein the forwarded license request includes a license request appropriate for licensing the host device.

26. The system of 25, wherein the received license data authorizes the host device to access the information contained within the digital data file, and further wherein the license data can be converted to license data authorizing the portable digital media device to access the information contained within the digital data file.

27. The system of 18, wherein the host device is configured to forward a license request appropriate for licensing the portable digital media device.
